(19) United States
(12) Patent Application Publication
(10) Pub. No.: US 2017/0161364 A1
(43) Pub. Date: Jun. 8, 2017

(54) GENERATING MESSAGES USING KEYWORDS

(71) Applicant: International Business Machines Corporation, Armonk, NY (US)

(72) Inventors: Adam T. Clark, Mantorville, MN (US); Jeffrey K. Huebert, Rochester, MN (US); Aspen L. Payton, Byron, MN (US); John E. Petri, St. Charles, MN (US)

(21) Appl. No.: 14/960,480

(22) Filed: Dec. 7, 2015

(51) Int. Cl. G06F 17/30; H04L 12/58; G10L 15/26; H04L 29/08

(52) U.S. Cl. CPC G06F 17/30684; H04L 67/306; H04L 67/22; H04L 51/04; G06F 17/30675; G10L 15/265

(57) ABSTRACT

Using keywords, a system can generate a message from a sender to a recipient. The system can first identify the set of keywords and a relationship type between the sender and recipient of the message. The system can then determine the message using natural language processing, the relationship type, and the keywords. The system can then generate that message.

### BACKGROUND

The present disclosure relates to message generation, and more specifically, to generating messages using keywords.

Electronic messages including text messages can be sent between two or more mobile phones, or other fixed or portable devices over a network. Text messaging originally referred to messages sent using the Short Message Service and has grown to include image, video, and sound content. Text messages can be used to interact with automated systems, for example, to order products or participate in contests.

In some cases, a text message can be sent when a sender types a message directly into a device. In some texting applications, the message that is typed can be altered by an autocorrect feature. In this case, the application may automatically correct or replace a detected grammatical error. For example, a misspelled word may be automatically replaced with a correctly spelled version of the word.

### SUMMARY

Embodiments of the present disclosure may be directed toward a method for generating a message based on a set of keywords. A system may identify a set of keywords that are associated with a sender and a first recipient. The system may also identify a first relationship type between the sender and the first recipient. Based on natural language processing (NLP), and using the first relationship type and the keywords, the system may determine the message. The message may then be generated.

Embodiments of the present disclosure may be directed toward a system for generating a message based on a set of keywords. The system may include a computer readable storage medium with program instructions stored thereon. The system may also have one or more processors configured to execute the program instructions to perform a set of steps including identifying a set of keywords. The set of keywords may be associated with a sender and a first recipient. The system may also identify a first relationship type between the sender and the first recipient. Based on natural language processing (NLP), and using the first relationship type and the keywords, the system may determine the message. The message may then be generated.

Embodiments of the present disclosure may be directed toward a computer program product for generating a message based on a set of keywords. The computer program product may have a computer readable storage medium with program instructions embodied therewith. The computer readable storage medium need not be a transitory signal per se. The program instructions may be executable by a computer processor to cause the processor to perform a series of steps. These steps may include identifying a set of keywords. The set of keywords may be associated with a sender and a first recipient. A first relationship type between the sender and the first recipient may also be identified. Based on natural language processing (NLP), and using the first relationship type and the keywords, the message may be determined. The message may then be generated.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an example computing environment in which embodiments of the present disclosure may be implemented.

FIG. 2 depicts a block illustration of an example system architecture, including a natural language processing system, configured to analyze keywords and a corpus of data to generate a message, according to embodiments.

FIG. 3 depicts a block diagram of an example high-level logical architecture of a Question Answering (QA) system configured to use keywords and ingested communication data to generate messages, according to embodiments.

FIG. 4 depicts an embodiment of a candidate identification and scoring module, according to embodiments.

FIG. 5 depicts a block diagram of an example high-level logical architecture of a system configured to use keywords, ingested communication data, and profile data to generate messages, according to embodiments.

FIG. 6 depicts a flow diagram of a method for generating a message based on received keywords, according to embodiments.

FIG. 7 depicts a flow diagram of a method for generating a message using scoring and based on keywords, according to embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to message generation, more particular aspects relate to generating messages based on keywords. While the present disclosure is not necessarily limited to such applications, various aspects of the disclosure may be appreciated through a discussion of various examples using this context.

Various embodiments are directed toward a computer system that can generate full text messages based on keywords provided by a user. As discussed herein, the message that is generated can be based on a relationship that exists between the sender and recipient of the message, as informed by prior message exchanges between the two, identities of each, and social media activity of each of the sender and recipient.

According to embodiments, the computer system can be configured to identify keywords that are entered or sent to the system. For example, a user—the sender—may type three keywords in a texting space to a friend into a texting application on his phone. In some embodiments, the keywords may be received via voice or audio entry (e.g., the sender may speak into his phone), and the words may be converted to text for handling by the system. The system can identify these keywords, as well as the sender and the intended recipient user of the message—the recipient.

The system may be configured to then identify a relationship type between the sender and the recipient. For example, the system may determine that the sender and the recipient are friends. In some embodiments, the system may identify the relationship type using natural language processing (NLP). The system may also determine a more or less specific relationship type, for example, rather than grouping the sender and the recipient into a relationship type “friends”, the system could identify them as “not related” or “nonprofessional acquaintances”. In other cases, the system could group them into a more specific relationship type, for example, “high school friends” or “inner circle” friends. Based on the relationship type, the keywords, and NLP, the system can then generate the message. As discussed herein, the message may be determined by scoring a number of candidate messages, based on, for example, the user's past interactions with other users in that particular relationship type. The scoring could also take into account the recipient's recent communications and social media activity, in order to customize the message to more appropriately suit, for example, the recipient's current emotional state. In embodiments, the message may be determined by selecting the highest scoring candidate message, where the scoring indicates a likelihood that the answer is correct (e.g., a confidence that the candidate message is the most appropriate message for the keywords). The system can then be configured to generate the message. In some embodiments, the message can then be sent to the recipient. In other embodiments, the message may be presented to the sender, who can then choose to review, edit, or send the message.

In some embodiments, the system may be able to receive feedback from a user, and update accordingly, in order to improve future message generating. For example, in some embodiments the sender may make a particular selection within the message. For example, the sender may edit the message, indicating that one or more words, letters, or punctuation marks was not correct, or was not the user's preferred version of the message. In embodiments, this selection can be received by the system and used by the system to update a sender profile. The sender profile may contain data about the sender including message preferences, punctuation or capitalization preferences, or communication history data.

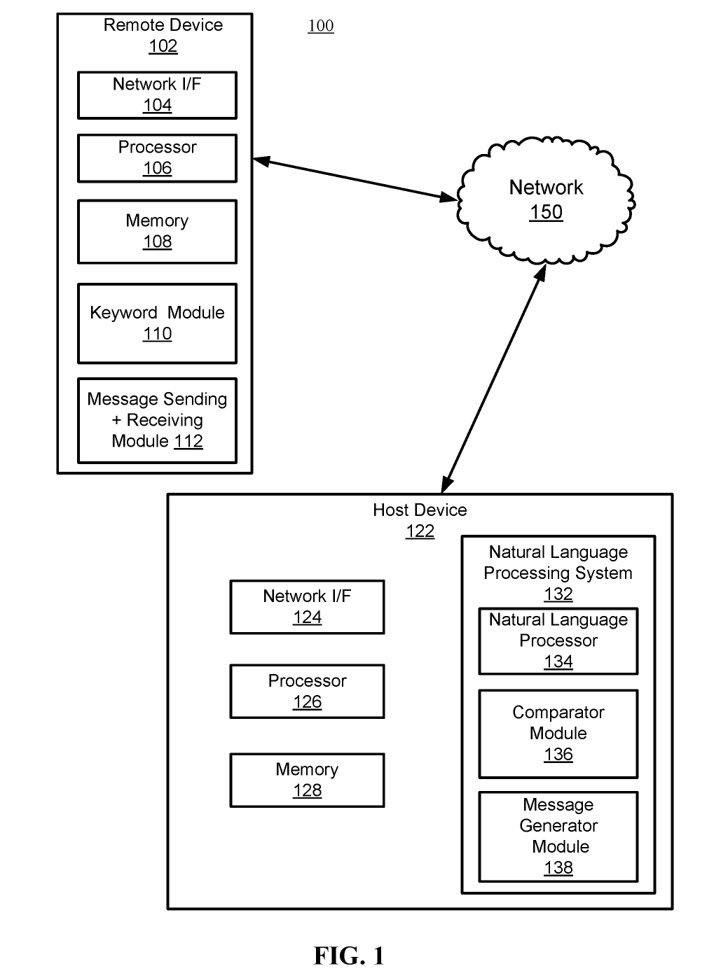

FIG. 1 depicts a block diagram of an example computing environment 100 in which embodiments of the present disclosure may be implemented. In embodiments, the computing environment 100 may include a remote device 102 and a host device 122.

According to embodiments, the host device 122 and the remote device 102 may be computer systems. The remote device 102 and the host device 122 may include one or more processors 106 and 126 and one or more memories 108 and 128, respectively. The remote device 102 and the host device 122 may be configured to communicate with each other through an internal or external network interface 104 and 124. The network interfaces 104 and 124 may be, e.g., modems or interface cards. The remote device 102 and/or the host device 122 may be equipped with a display or monitor. Additionally, the remote device 102 and/or the host device 122 may include optional input devices (e.g., a keyboard, mouse, scanner, or other input device), and/or any commercially available or custom software (e.g., browser software, communications software, server software, natural language processing software, search engine, and/or web crawling software, filter modules for filtering content based upon predefined parameters, etc.). In some embodiments, the remote device 102 and/or the host device 122 may be servers, desktops, laptops, or hand-held devices.

The remote device 102 and the host device 122 may be distant from each other and may communicate over a network 150. In embodiments, the host device 122 may be a central hub from which a remote device 102 and other remote devices (not pictured) can establish a communication connection, such as in a client-server networking model. In some embodiments, the host device 122 and remote device 102 may be configured in any other suitable network relationship (e.g., in a peer-to-peer configuration or using another network topology).

In embodiments, the network 150 can be implemented using any number of any suitable communications media. For example, the network 150 may be a wide area network (WAN), a local area network (LAN), the Internet, or an intranet. In certain embodiments, the remote device 102 and the host device 122 may be local to each other, and communicate via any appropriate local communication medium. For example, the remote device 102 and the host device 122 may communicate using a local area network (LAN), one or more hardwire connections, a wireless link or router, or an intranet. In some embodiments, the remote device 102, the host device 122, and any other devices may be communicatively coupled using a combination of one or more networks and/or one or more local connections. For example, the remote device 102 may be hardwired to the host device 122 (e.g., connected with an Ethernet cable) while a second device (not pictured) may communicate with the host device using the network 150 (e.g., over the Internet).

In some embodiments, the network 150 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 150.

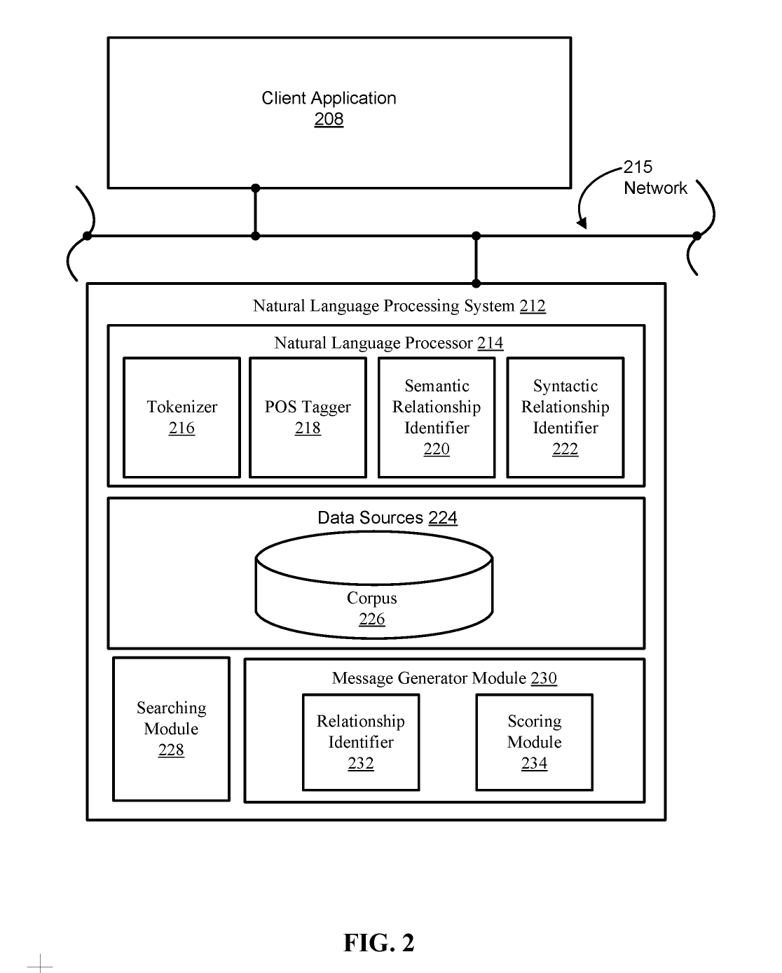

In some embodiments, the remote device 102 may enable users to submit (or may submit automatically with or without a user selection) keywords (e.g., words typed into a messaging application) to the host devices 122. In some embodiments, the user may enter and/or submit keywords via a keyword module 110. In some embodiments, the host device 122 may include a natural language processing system 132. The natural language processing system 132 may include a natural language processor 134, a comparator module 136, and a message generator module 138. The natural language processor 134 may include numerous subcomponents, such as a tokenizer, a part-of-speech (POS) tagger, a semantic relationship identifier, and a syntactic relationship identifier. An example natural language processor is discussed in more detail in reference to FIG. 2. The natural language processor 134 may be configured to perform natural language processing to ingest a set of keywords (e.g., keywords submitted by remote device 102) and/or to ingest historical message data (e.g., message data submitted by message sending and receiving module 112 of remote device 102).

The comparator module 136 may be implemented using a conventional or other search engine, and may be distributed across multiple computer systems. The comparator module 136 may be configured to search one or more databases or other computer systems for content ingested by the natural language processor 134. For example, the comparator module 136 may be configured to compare ingested keywords (e.g., keywords received from remote device 102) with a corpus or corpora of ingested communication data (e.g., communication data received from remote device 102) in order to help identify content that may appear in candidate messages.

The message generator module 138 may be configured to analyze a set of keywords and the historical messaging data (e.g., historical messaging data analyzed by the comparator module 136), to generate candidate messages which may be scored, with one or more of the candidate messages being provided to the remote device 102 (e.g., sent to the message sending and receiving module 112). The message generator module 138 may include one or more modules or units, and may utilize the comparator module 136, to perform its functions (e.g., to determine a relationship between the sender and the recipient of the message, to determine the relationship between the keywords and previous communications, or to determine a probable tone of a candidate message), as discussed in more detail in reference to FIG. 2.

While FIG. 1 illustrates a computing environment 100 with a single host device 122 and a single remote device 102, suitable computing environments for implementing embodiments of this disclosure may include any number of remote devices and host devices. The various models, modules, systems, and components illustrated in FIG. 1 may exist, if at all, across a plurality of host devices and remote devices. For example, some embodiments may include two remote devices or two host devices. The two host devices may be communicatively coupled using any suitable communications connection (e.g., using a WAN, a LAN, a wired connection, an intranet, or the Internet). The first host device may include a natural language processing system configured to receive and analyze content from historical communications or a user profile, and the second host device may include a natural language processing system configured to receive and analyze a set of keywords.

It is noted that FIG. 1 is intended to depict the representative major components of an exemplary computing environment 100. In some embodiments, however, individual components may have greater or lesser complexity than as represented in FIG. 1, components other than or in addition to those shown in FIG. 1 may be present, and the number, type, and configuration of such components may vary.

FIG. 2 depicts a block illustration of an example system architecture 200, including natural language processing system 212, configured to analyze keywords and a corpus of data to generate a message, according to embodiments. In embodiments, a remote device (such as remote device 102 of FIG. 1) may submit keywords (e.g., keywords to be sent as a message from a sender to a recipient) to be analyzed to the natural language processing system 212 which may be housed on a host device (such as host device 122 of FIG. 1). A remote device (e.g., remote device 102 of FIG. 1) may include a client application 208, which may itself involve one or more entities operable to generate or modify keywords or messages, or communication or other profile data that may then be dispatched to a natural language processing system 212 via a network 215.

In embodiments, the natural language processing system 212 may respond to content submissions sent by a client application 208. Specifically, the natural language processing system 212 may analyze keywords or historical communication data or other profile content to identify characteristics about the received content (e.g., a theme, main idea, and characters). In some embodiments, the natural language processing system 212 may include a natural language processor 214, data sources 224, a searching module 228, and a message generator module 230. The natural language processor 214 may be a computer module that analyzes the received content. The natural language processor 214 may perform various methods and techniques for analyzing the received content (e.g., syntactic analysis, semantic analysis, etc.). The natural language processor 214 may be configured to recognize and analyze any number of natural languages. In some embodiments, the natural language processor 214 may parse passages of the received content. Further, the natural language processor 214 may include various modules to perform analyses of electronic documents (e.g., social media pages, text message histories). These modules may include, but are not limited to, a tokenizer 216, a part-of-speech (POS) tagger 218, a semantic relationship identifier 220, and a syntactic relationship identifier 222.

In some embodiments, the tokenizer 216 may be a computer module that performs lexical analysis. The tokenizer 216 may convert a sequence of characters into a sequence of tokens. A token may be a string of characters included in written passage and categorized as a meaningful symbol. Further, in some embodiments, the tokenizer 216 may identify word boundaries in content and break any text passages within the content into their component text elements, such as words, multiword tokens, numbers, and punctuation marks. In some embodiments, the tokenizer 216 may receive a string of characters, identify the lexemes in the string, and categorize them into tokens.

Consistent with various embodiments, the POS tagger 218 may be a computer module that marks up words in passages to correspond to particular parts of speech. The POS tagger 218 may read a passage or other text in natural language and assign a part of speech to each word or other token. The POS tagger 218 may determine the part of speech to which a word (or other text element) corresponds based on the definition of the word and the context of the word. The context of a word may be based on its relationship with adjacent and related words in a phrase, sentence, or paragraph. In some embodiments, the context of a word may be dependent on one or more previously analyzed content (e.g., the content of one social media post may shed light on the meaning of text elements in related social media post, or content of a first comment by a user on an Internet forum may shed light on meaning of text elements of a second comment by that user on the same or different Internet forum). Examples of parts of speech that may be assigned to words include, but are not limited to, nouns, verbs, adjectives, adverbs, and the like. Examples of other part of speech categories that POS tagger 218 may assign include, but are not limited to, comparative or superlative adverbs, wh-adverbs, conjunctions, determiners, negative particles, possessive markers, prepositions, wh-pronouns, and the like. In some embodiments, the POS tagger 218 may tag or otherwise annotate tokens of a passage with part of speech categories. In some embodiments, the POS tagger 218 may tag tokens or words of a passage to be parsed by the natural language processing system 212.

In embodiments, the semantic relationship identifier 220 may be a computer module that may be configured to identify semantic relationships of recognized text elements (e.g., words, phrases) in received content. In some embodiments, the semantic relationship identifier 220 may determine functional dependencies between entities and other semantic relationships.

In embodiments, the syntactic relationship identifier 222 may be a computer module that is configured to identify syntactic relationships in a passage composed of tokens. The syntactic relationship identifier 222 may determine the grammatical structure of sentences such as, for example, which groups of words are associated as phrases and which word is the subject or object of a verb. The syntactic relationship identifier 222 may conform to formal grammar.

In some embodiments, the natural language processor 214 may be a computer module that parses received content and generates corresponding data structures for one or more portions of the received content. For example, in response to receiving a set of email exchanges at the natural language processing system 212, the natural language processor 214 may output parsed text elements from the email messages as data structures. In some embodiments, a parsed text element may be represented in the form of a parse tree or other graph structure. To generate the parsed text element, the natural language processor 214 may trigger computer modules 216-222.

In some embodiments, the output of natural language processor 214 (e.g., ingested content) may be stored within data sources 224, such as corpus 226. As used herein, a corpus may refer to one or more data sources, such as the data sources 224 of FIG. 2. In some embodiments, the data sources 224 may include data warehouses, corpora, data models, and document repositories. In some embodiments, the corpus 226 may be a relational database.

In embodiments, the searching module 228 may search data sources 224 including the corpus 226 of ingested data. Using data associated with the keywords (e.g., metadata) including the sender, intended recipient, date, time, and location of the keyword entry, the searching module 228 may search the data sources 224 for data relevant to the candidate message generation. In embodiments, the message generator module 230 may be a computer module that generates one or more candidate messages based on ingested keywords and other ingested data including historical communications and relationship type-based communications.

In some embodiments, the message generator module 230 may include a relationship identifier 232 and a scoring module 234. The relationship identifier 232 may identify a relationship between ingested keywords and ingested communication or profile data. This may be done by searching, using the keywords, the ingested content of the communication data including past messages (e.g., text messages, email messages, social media messages, and instant messages) and metadata about those messages (including date, time, location, or other data about the sent and received messages). In embodiments, this search may be conducted over only the data identified as relevant based on the results of the search by the searching module 228. Certain similarities between keywords and the ingested contented may be weighted more heavily than others. For example, content combined with time and date of the messages may be important, and so a keyword matching content sent at about the same time and weekday in a set of earlier messages may indicate a relationship between the keyword and the earlier content. In some embodiments, the relationship identifier 232 may also search the corpus 226 for additional data associated with the keyword, the sender, the recipient, or the content of the messages.

In some embodiments, after relationship identifier 232 identifies a relationship between the keywords and the ingested content, the scoring module 234 may evaluate the relationship between the found content (e.g., from past communications) and the keywords. The relationship may be evaluated based on a set of relatedness criteria in order to determine whether or not the relationship satisfies a relatedness threshold. In some embodiments, this can help to ensure that candidate messages that are generated and evaluated are only those relevant to the particular keywords, the sender, and the recipient. In some embodiments, after a relationship identified by the relationship identifier 232 satisfies the standards of the scoring module 234, the message generator 230 may generate a list of candidate messages.

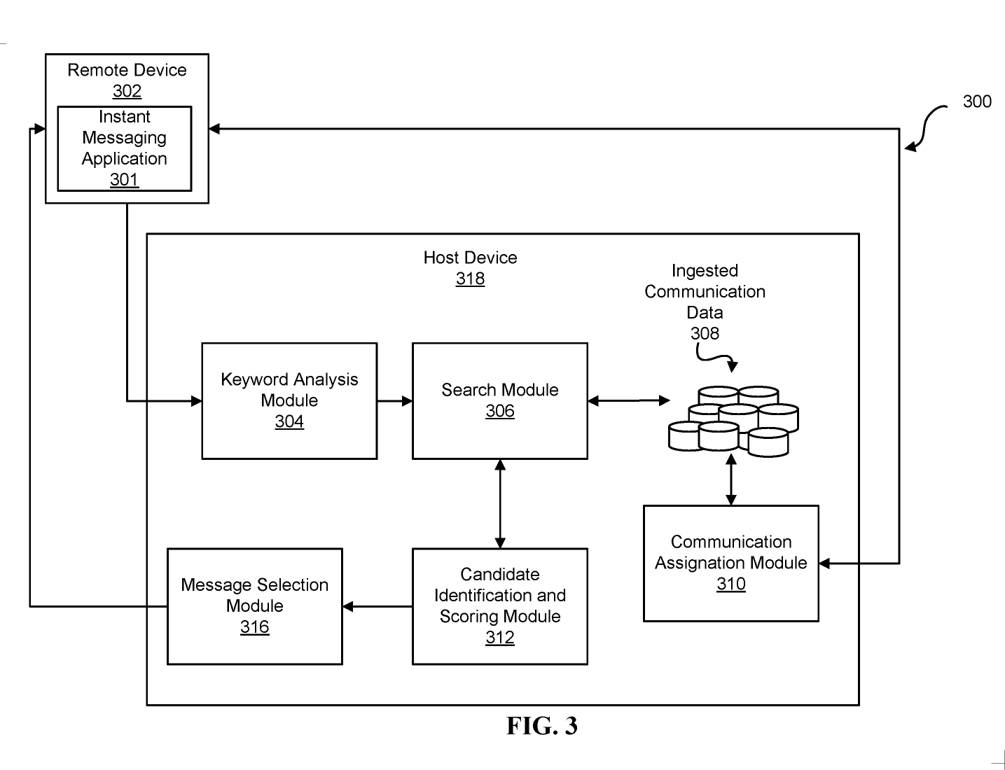

FIG. 3 depicts a block diagram of an example high-level logical architecture of a Question Answering (QA) system configured to use keywords and ingested communication data to generate messages, according to embodiments. In some embodiments, host device 318 and remote device 302 of the QA system 300 may be embodied by host device 122 and remote device 102 of FIG. 1, respectively. In some embodiments, the keyword analysis module 304, located on host device 318, may receive a set of one or more keywords (e.g., a natural language question, a string of nouns, a noun and related verb) from a remote device 302, and can analyze the set of keywords to produce an ingested form of the set of keywords based on the content and context type of each keyword or the set as a whole.

In embodiments, the set of keywords can be received, by the remote device 302, from an instant messaging application 301, running on the remote device 302. The set of keywords may have been entered into an instant messaging application 301, for example by a user typing or speaking into the remote device 302. In some embodiments, the set of keywords may be received at the user device in an order other than the order in which they may be intended to appear in the message. For example, a user may speak the set of keywords into a device in a different order than the user wishes the words to appear in the message. For example, the user may speak the set of keywords backward, in an effort to not convey to anyone listening the content of the message.

An analysis produced by keyword analysis module 304 may include, for example, the semantic type or form of the expected resulting message to be generated (e.g., a keyword of “what” may tend to indicate that the generated message will likely be a question). The keyword analysis module 304 may also identify a relationship that exists between the sender and the recipient of the keywords. This information may be received from the remote device 302, or it may be identified based on a search of relevant contact data stored in a contacts application on the remote device 302, or in another way.

In embodiments, the search module 306 may formulate queries from the output of the keyword analysis module 304 and may consult various resources e.g., databases or corpora, to retrieve content that is relevant to formulating messages (answers in a QA system paradigm) based on the keywords (questions in the QA system paradigm). In embodiments, the ingested communication data 308 may include a combination of historical messaging data as well as data associated with the messages including location, time, date, and other data associated with the messages. In some embodiments, the ingested communication data 308 may have been tagged during the ingesting of the historical messages in which the data was included for tone, style, level of formality or other linguistic trait conveyed through syntax and diction. In some embodiments, ingested communication data 308 may include general communication data about the sender including emails, text messages, and other communications sent or received by the sender, organized without any respect to relationship type. In some embodiments, the ingested communication data 308 may be handled and sorted by a communication assignation module 310. In embodiments, the communication assignation module 310 may partition the ingested communication data 308 and assign it to different categories based on a relationship type. For example, some ingested communication data 308 may be sorted into a friend relationship type while other ingested communication data 308 may be sorted into a coworker relationship type, depending on the relationship between the sender and recipient of the communication from which each piece of ingested communication data 308 was derived. One relationship type may reflect the type of relationship that exists between the sender and the intended recipient of the message to be generated by the keywords (e.g., the set of keywords received and analyzed by the keyword analysis module 304). Another relationship type may be a different relationship type that existed, for example, between the sender and different recipients of previously sent messages. This partitioning may separate data into one or more partitioned corpora, where in response to data, the system may search only a particular type of communication data. For example, sender-first type communication data may be searched in response to the system identifying that the recipient of a particular communication from the sender belongs to a ‘first relationship type’. In embodiments, the communication assignation module 310 may communicate directly with the remote device 302, in order to access or receive data about the sender and recipient of messages. The communication assignation module 310 can then work to assign to the search module 306 to search only through a particular portion of the ingested communication data 308, based on a relationship type between the sender and the recipient of the keyword-based message. In embodimsender-first relationship type communication data

In some embodiments, the search module 306 will search only the corpora designated by the communication assignation module 310, based on, for example, the relationship type. For example, the communication assignation module 310 may, for a particular keyword or set of keywords, partition the ingested communication data into professional and nonprofessional (i.e., not work-related) communications. Upon the identification of the sender's relationship to the recipient as professional, the search module 306, may search only the databases or corpora with a ‘professional’ assignation. Thus, past professional correspondences can be used to inform and generate the message to a professional colleague. Also, the set of data that has been designated as nonprofessional (e.g., communication history with friends and family) may not be used in the generation of the professional message.

In embodiments, a candidate identification and scoring module 312 may use the output of the search module 306 to assemble, identify, and score candidate messages (answers) for the set of keywords (question). From the search results, one or more candidate messages may be assembled, where the candidate messages include messages that are determined to be likely complete messages based on the set of keywords. For example, if a set of keywords included “movie” and “Friday”, the candidate messages could include “Do you want to go to a movie on Friday?”, “Sorry, I'm going to a movie on Friday.”, and “What movie do you want to see on Friday?”. The candidate messages could then be scored based on the past messaging between the sender and recipients having the same relationship type as the relationship type between the sender and the current intended recipient or based on past messaging between the sender and the current intended recipient. For example, if the message was between a sender and a colleague, the candidate identification and scoring module 312 could determine, based on the results of the search conducted by the search module 306 of the ingested communication data 308 of one or more ‘professional’ communications corpora, that “Sorry, I'm going to a movie on Friday.” is the most likely message response. This could be based on the search of the ingested communication data 308 that indicates that there is little if any historical messaging that indicates that the sender goes to social events or other movies with this colleague. The data could also indicate that the colleague frequently invites the sender to an office networking event that occurs once monthly on Fridays. The system could score the candidate message “Do you want to go to a movie on Friday?” as the next most likely message, and the candidate message “What movie do you want to see Friday?” as the least likely message. The final ranking could be, for example, based on the fact that there was no previous communication between the sender and the recipient or the sender and any of the sender's professional contacts that discussed arrangements for going to a movie.

In embodiments, based on the scoring of the candidate messages of the candidate identification and scoring module 312, the message selection module 316 can select a message (answer) to complete the received keywords (question). In embodiments, this selection may be made by simply selecting the highest scored candidate answer. In other embodiments, an accuracy threshold may exist, which requires a top score to meet a threshold before it is selected. For example, if a set of three candidate messages were received by the message selection module, with the top score (e.g., a confidence score) being 63, and the score indicating the likelihood that the candidate message was a correct message (answer) for the keywords, the system may transmit an error message or a request for additional keywords. In other embodiments, one or more thresholds may exist which, if met, would qualify the candidate message to be sent by the message selection module 316 to the remote device 302. For example, if two candidate messages were received by the message selection module 316, with scores of 96 and 96, respectively, settings may allow for the message selection module 316 to transmit both candidate messages to the device, with the scores. Input could then be received from a user of the remote device 302 as to which message is most correct, and that message could be selected for transmission.

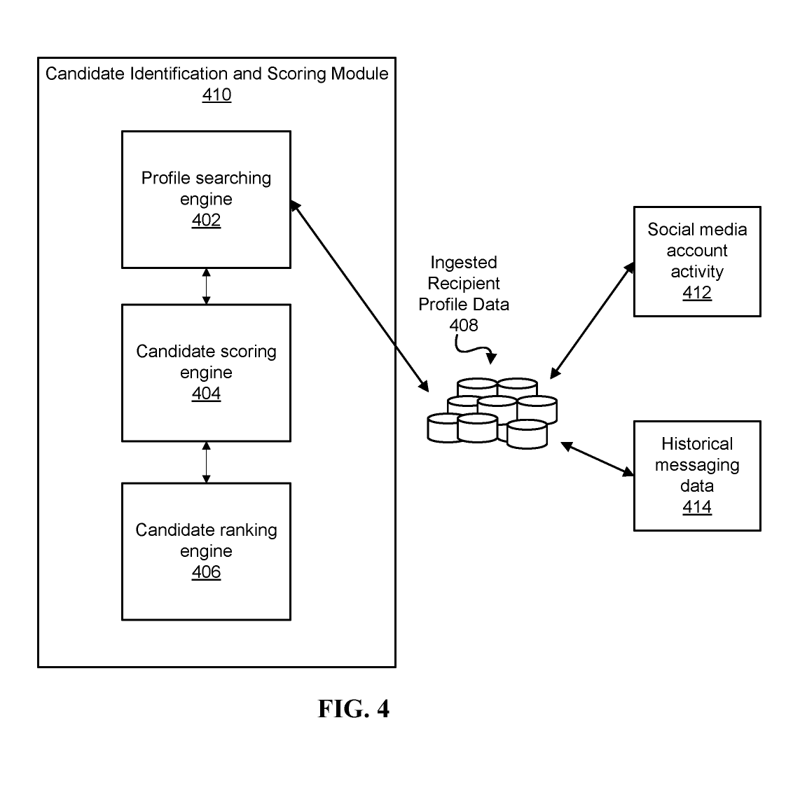

FIG. 4 depicts an embodiment of a candidate identification and scoring module 410, according to embodiments. In embodiments, this module can be the candidate identification and scoring module 312 of FIG. 3, and may be housed in a host device 318. In embodiments, the module 410 may comprise one or more engines including profile searching engine 402, candidate scoring engine 404, and candidate ranking engine 406, which may communicate with one or more databases including those storing ingested recipient profile data 408. The candidate identification and scoring module 410 may receive data from a searching module and, based on the results, assemble one or more candidate messages, as described in FIG. 3 and elsewhere. In embodiments, the profile searching engine 402 can access and search ingested recipient profile data 408, for data relevant to each of the candidate messages. The ingested recipient profile data 408 can include data from sources including social media account activity 412 and historical messaging data 414. The recipient profile can be updated regularly, at predetermined intervals, or upon a user selection. In other words, it can contain very recent data about the intended recipient of the message. Examples of data included in the recipient profile include: location data based on social media “check-ins”, historical communication data with the sender and other recipients, recent posts, updates, and LIKES on the recipient's social media account, and other data relevant to the recipient.

In embodiments, using the search results received from the profile searching engine 402, the candidate scoring engine 404 can assign to each of the candidate answers an appropriateness score. The appropriateness score can indicate a level of appropriateness the wording in the candidate message may be, relative to the recipient. For example, if the recipient—based on outgoing and incoming email, social media check-ins, and relative time on social media accounts (versus usual usage)—is having a very busy day, a lengthy candidate message may receive a lower rating than a slightly-less precise but shorter candidate message. In other embodiments, an equally or more precise but shorter answer may be used. For example, one or more abbreviations with which the user is familiar may be used, rather than the complete, unabbreviated words. In this way, the recipient can be accounted for in the generating of the message. The candidate ranking engine 406 can then, using the appropriateness score, as well as any other scores assigned to the candidate answers (for example, an initial confidence score as described in FIG. 3), rank the candidate messages.

In embodiments, the candidate ranking engine 406 can rank the messages by weighting the various scores assigned to each candidate message differently, based on importance or other factors. In other embodiments, the candidate ranking engine 406, may rank the candidate messages first based on an initial score (e.g., the score assigned in FIG. 3), in order to determine a discrete set of candidate answers (e.g., a subset of the initial set of candidate answers). The discrete set of candidate answers could then be ranked based on the scores determined from the recipient profile data 408. For example, if three candidate messages all received very high initial scores, and were determined to meet a certain similarity threshold (which could indicate a particular level of substantive similarity), a setting in the candidate ranking engine 406 could provide for a second phase of ranking, wherein the three candidate messages were then ranked according to their appropriateness score. The ranked candidate messages could then be passed from the candidate ranking engine 406 of the candidate identification and scoring module 410 to a message selection and generating module, e.g., message selection module 316 of FIG. 3.

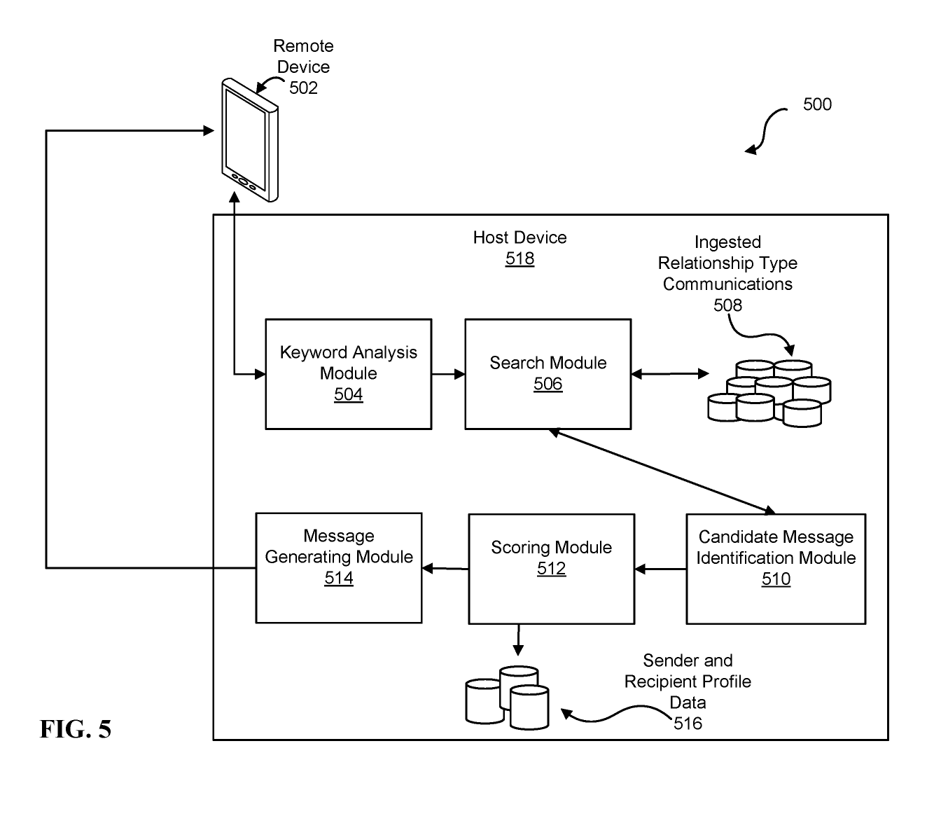

FIG. 5 depicts a block diagram of an example high-level logical architecture of a system 500 configured to use keywords, ingested communication data, and profile data to generate messages, according to embodiments. Embodiments of system 500 may be similar to those of system 300 in FIG. 3, with like modules performing like functions. A host device 518 may be similar to host device 318 of FIG. 3, and may host several modules including keyword analysis module 504, search module 506, candidate message identification module 510, scoring module 512, and message generating module 514. Embodiments may also include one or more databases within the host device, or communicatively coupled thereto, as described herein, including ingested relationship type communications 508 and sender and recipient profile data 516.

A keyword analysis module 504 may receive a set of one or more keywords from a remote device 502. The keyword analysis module 504 may analyze the keywords and send, to a search module 506, the analysis. The received analysis of the keywords can then be used by the search module 506 to search a set of ingested relationship type communications data 508. In embodiments, the search may be conducted using the keywords themselves, or may be based off the keywords and the analysis (e.g., using synonyms, related words, relational words, etc.). The search may be of communication data of the particular type only. For example, if a relationship is identified between the sender and the recipient of the message as being “family” the system may only ingest and search historical family communications. In embodiments, however, the system may have ingested and sorted, prior to keyword entry, the one or more communications. Thus, rather than ingesting and searching only a particular type of communication in response to the keyword entry, the system could search only a particular subset of already ingested and sorted communication data.

In embodiments, a candidate message identification module 510 may receive data from the search module, which could include search results and candidate message content. The candidate message identification module 510 could identify, from the received data, one or more candidate messages for the keywords. In other embodiments, the candidate message identification module 510 could assemble, from the search data, one or more candidate messages. The set of candidate messages could then be sent to a scoring module 512. Scoring module 512 can access and search one or more sender and recipient profiles 516. In embodiments, the data contained in the sender and recipient profile may be similar to the recipient profile data 408 in FIG. 4, but for the appropriate party, respectively. It may include social media account usage history, email history, history of applications accessed on a device, historical communication data, and other data relevant to the particular user. The scoring module 512, can then score the candidate messages based on data in the sender and recipient profile. In some instances only one of the sender or recipient profile may be used in the scoring. The scoring module 512 can then send, to the message generating module 514, the highest scoring candidate message as the message to satisfy the keywords. The message generating module 514 can then generate the message and send it to the remote device 502.

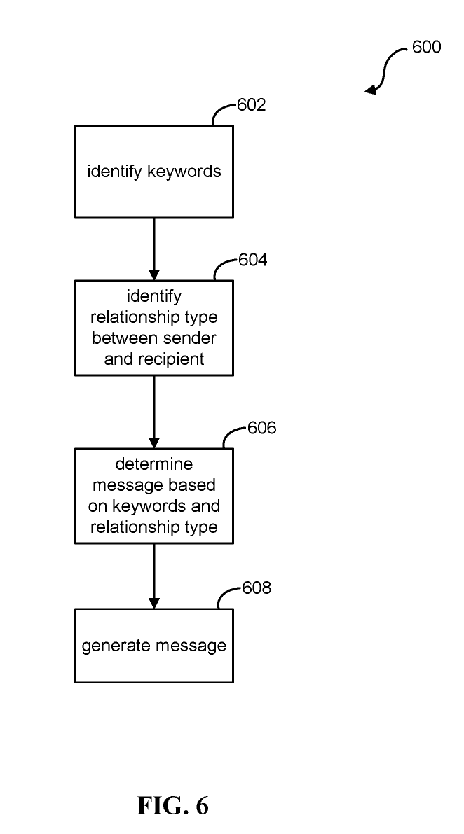

FIG. 6 depicts a flow diagram of a method 600 for generating a message based on received keywords, according to embodiments. The system may begin when a set of one or more keywords is identified, per 602. For example, a system may receive, from a cell phone, a set of four keywords. The keywords may be associated with a sender and a recipient. For example, if the keywords were typed into a texting application on a smartphone, the sender could be the user who is typing the keywords and the recipient could be the intended recipient of the message, as specified within the texting application. The system may then identify a relationship type between the sender and the recipient, per 604. This relationship type may be acquired from a contacts database on the sender's device, identified using NLP and historical usage data, specified by the sender, or in another way. For example, the system may determine that the sender and recipient are friends from graduate school, and so there relationship may be identified as “friends”. The system can then, based on the keywords and the relationship type, determine the message, per 606. For example, a corpus of historical communication data between the sender and a set of his friends may be searched using the keywords. In some embodiments, the system may use only data between the sender and friends in determining the message, while not utilizing data between the sender and other relationship categories (e.g., family, coworkers, classmates, or others). As described herein, the determining may also include scoring candidate answers one or more times, based on one or more criteria. The system may then generate the message, per 608. In some embodiments, the system may send the message to, for example, a smartphone, in order to allow the user to confirm the message and send it. In another example, the message may be delivered automatically to the recipient once it is generated.

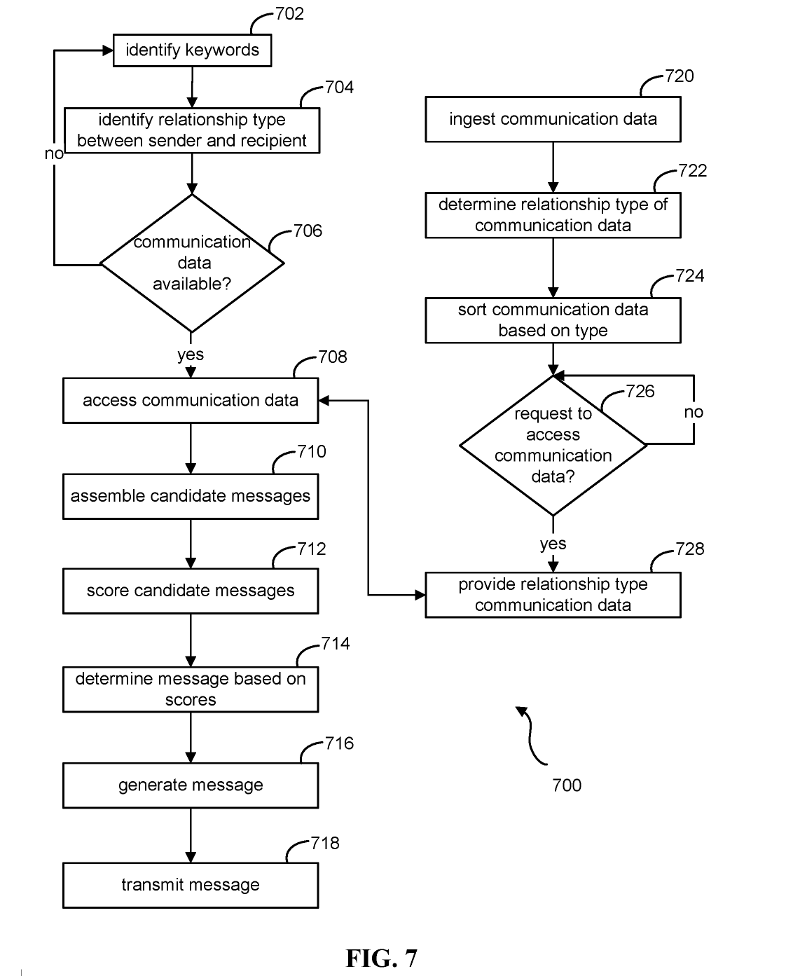

FIG. 7 depicts a flow diagram of a method 700 for generating a message using scoring and based on keywords, according to embodiments. The method may begin when the system identifies a set of one or more keywords, per 702. The system may then, as described herein, identify a relationship between the sender and the recipient, per 704. The system may then determine whether or not communication data (e.g., data from prior communications between the sender and recipient, ingested social media content posted by the recipient) is available, per 706. If no communication data is available, the system may then request more or additional keywords from the system (or the user thereof), per 702. If communication data is available, per 706, the system may access the communication data, per 708. In embodiments, the communication data may be sorted by relationship type by, for example, communication assignation module 310 of FIG. 3.

In some embodiments, sorting communication data based on relationship type may be performed utilizing operations 720 to 728 of the method 700. In some embodiments, the some of the operations 720 to 728 may be performed prior to operations 702 to 718. To group the data based on relationship type, the system may ingest communication data, per 720, and determine a relationship type associated with the communication data, per 722. For example, the communication data may be a series of emails between a sender and his mother. In this case, the system may determine that the communication belongs to the relationship type “family”. The system can then sort the communication data based on the type, per 724. Once the data has been sorted, the system can monitor for a request to access the communication data, per 726. If a request has been received, the system can provide, to e.g., search module 306 of FIG. 3, the communication data for the particular relationship type, per 728. If no request is detected, the system can continue to monitor for a request.

The system can use the communication data received to assemble a set of candidate messages based on the set of keywords, per 710. The system can then score the candidate messages, per 712, and determine the message based on the scoring, per 714. The scoring may be used to determine the message as described herein, and may involve a simple ranking of scores, multiples stages of ranking based on a variety of scores, a weighted algorithm or algorithms, or in another way. The system can then generate the message, per 716, and transmit the message, per 718. In some embodiments, the message may be transmitted to the recipient. In other embodiments, the message may be transmitted to the sender to allow the sender to confirm the text prior to delivery to the recipient.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for generating a message based on a set of keywords, the method comprising:
identifying a set of keywords, the set of keywords associated with a sender and a first recipient;
identifying a first relationship type between the sender and the first recipient;
determining, based on natural language processing (NLP), the first relationship type, and the keywords, the message; and
generating the message.

2. The method of claim 1, further comprising:
ingesting, prior to the determining and using NLP, a communication from a corpus of communication data involving the sender and a plurality of recipients, the communication being associated with the sender and a second recipient;
determining, based on the ingested communication, that a relationship between the sender and the second recipient belongs to the first relationship type; and
assigning, based on the first relationship type, the communication to a first relationship type corpus, the first relationship type corpus being one of a plurality of relationship type corpora.

3. The method of claim 2, wherein the determining the message comprises:
ingesting, using NLP, the keywords;
searching, based on the keywords, the first relationship type corpus;
identifying, based on the searching, one or more candidate messages;
scoring the one or more candidate messages, the scoring including a score for each of the one or more candidate messages, each score indicating a likelihood that a corresponding candidate message is the message; and
determining, based on the scoring, the message.

4. The method of claim 3, wherein the scoring the one or more candidate messages further comprises:
ingesting a first recipient profile for the first recipient, the first recipient profile comprising historical data about the first recipient including historical messaging data and past social media account activity;
assigning, using NLP and to each candidate message of the one or more candidate messages, an appropriateness score, each appropriateness score indicating a level of appropriateness that a corresponding candidate message is to the first recipient, based the first recipient profile; and
ranking, based on the appropriateness scores, the one or more candidate messages.

5. The method of claim 1, wherein the determining comprises:
ingesting, using NLP, the keywords;
searching, based on the keywords, a corpus of communication data;
identifying, using NLP and based on the searching, one or more candidate messages;
scoring each of the one or more candidate messages based on a profile for the sender and a profile for the first recipient, each profile comprising recent historical social media account usage, historical messaging data, internet browsing history, and historical email usage; and
identifying, based on the scoring and from the one or more candidate messages, the message.

6. The method of claim 5, wherein the historical messaging data included in the profile for the sender comprises messaging data about communications between the sender and recipients of the first relationship type.

7. The method of claim 1, wherein the determining comprises:
generating, using NLP, a set of one or more candidate messages;
scoring the one or more candidate messages based on a search of a corpus of sender-first relationship type communication data, the communication data including communications between the sender and recipients of the first relationship type, the corpus of sender-first relationship type communication data ingested using NLP; and
identifying, based on the scoring and from the one or more candidate messages, the message.

8. The method of claim 1, further comprising:
receiving, prior to the identifying the set of keywords, the set of keywords in an audio format; and
translating, from the audio format to a text format, the set of keywords.

9. The method of claim 1, wherein the set of keywords were received as a text-based input from a user.

10. The method of claim 1, further comprising receiving, from a user device, the set of keywords, wherein the set of keywords were received at the user device from a user in an order other than an order in which they appear in the message.

11. The method of claim 1, further comprising:
sending, to the sender, the message;
receiving, from the sender, a selection, the selection indicating a correction of the message; and
updating, based on the receiving, a sender profile, the sender profile associated with the sender and containing data about communication history and preferences of the sender.

12. A system for generating a message based on a set of keywords, the system comprising:
a computer readable storage medium with program instructions stored thereon; and
one or more processors configured to execute the program instructions to perform a method comprising:
identifying a set of keywords, the set of keywords associated with a sender and a first recipient;
identifying a first relationship type between the sender and the first recipient;
determining, based on natural language processing (NLP), the first relationship type, and the keywords, the message; and
generating the message.

13. The system of claim 12, wherein the method further comprises:
ingesting, prior to the determining and using NLP, a communication from a corpus of communication data involving the sender and a plurality of recipients, the communication being associated with the sender and a second recipient;
determining, based on the ingested communication, that a relationship between the sender and the second recipient belongs to the first relationship type; and
assigning, based on the first relationship type, the communication to a first relationship type corpus, the first relationship type corpus being one of a plurality of relationship type corpora.

14. The system of claim 13, wherein the determining the message comprises:
ingesting, using NLP, the keywords;
searching, based on the keywords, the first relationship type corpus;
identifying, based on the searching, one or more candidate messages;
scoring the one or more candidate messages, the scoring including a score for each of the one or more candidate messages, each score indicating a likelihood that a corresponding candidate message is the message; and
determining, based on the scoring, the message.

15. The system of claim 14, wherein the scoring the one or more candidate messages further comprises:
ingesting a first recipient profile for the first recipient, the first recipient profile comprising historical data about the first recipient including historical messaging data and past social media account activity;
assigning, using NLP and to each candidate message of the one or more candidate messages, an appropriateness score, each appropriateness score indicating a level of appropriateness that a corresponding candidate message is to the first recipient, based the first recipient profile; and
ranking, based on the appropriateness scores, the one or more candidate messages.

16. They system of claim 12, wherein the determining comprises:
ingesting, using NLP, the keywords;
searching, based on the keywords, a corpus of communication data;
identifying, using NLP and based on the searching, one or more candidate messages;
scoring each of the one or more candidate messages based on a profile for the sender and a profile for the first recipient, each profile comprising recent historical social media account usage, historical messaging data, internet browsing history, and historical email usage; and
identifying, based on the scoring and from the one or more candidate messages, the message.

17. The system of claim 16, wherein the historical messaging data included in the profile for the sender comprises messaging data about communications between the sender and recipients of the first relationship type.

18. The system of claim 12, wherein the determining comprises:
generating, using NLP, a set of one or more candidate messages;
scoring the one or more candidate messages based on a search of a corpus of sender-first relationship type communication data, the communication data including communications between the sender and recipients of the first relationship type, the corpus of sender-first relationship type communication data ingested using NLP; and
identifying, based on the scoring and from the one or more candidate messages, the message.

19. The system of claim 12, wherein the method further comprises:
receiving, prior to the identifying the set of keywords, the set of keywords in an audio format; and
translating, from the audio format to a text format, the set of keywords.

20. A computer program product for generating a message based on a set of keywords, the computer program product comprising a compute readable storage medium having program instructions embodied therewith, wherein the computer readable storage medium is not a transitory signal per se, the program instructions executable by a computer processor to cause the processor to perform a method comprising:
identifying a set of keywords, the set of keywords associated with a sender and a first recipient;
identifying a first relationship type between the sender and the first recipient;
determining, based on natural language processing (NLP), the first relationship type, and the keywords, the message; and
generating the message.
